(19) United States
(12) Patent Application Publication
(10) Pub. No.: US 2017/0324585 A1
(43) Pub. Date: Nov. 9, 2017

(54) METHODS AND SYSTEMS FOR PRIORITIZING NAMESERVERS

(71) Applicant: BLUECAT NETWORKS, INC., Toronto (CA)

(72) Inventors: Richard N. Hyatt, Markham (CA); Thomas Borrel, Toronto (CA); Steven P. Meyer, Richmond Hill (CA)

(21) Appl. No.: 15/598,623

(22) Filed: May 18, 2017

Related U.S. Application Data
(63) Continuation of application No. 14/686,557, filed on Apr. 14, 2015, now abandoned.
(60) Provisional application No. 61/986,744, filed on Apr. 30, 2014.

(51) Int. Cl. H04L 12/64; H04L 29/08; H04L 12/875; H04L 12/26; H04L 12/24

(52) U.S. Cl. CPC H04L 12/6418; H04L 67/1036; H04L 67/101; H04L 67/1008; H04L 67/10; H04L 29/08; H04L 43/0864; H04L 43/00; H04L 41/5054; H04L 41/00; H04L 47/56

(57) ABSTRACT

Methods, devices and systems are disclosed for dynamically adjusting the load priority of a backup nameserver in a computer network based on the health and responsiveness of primary and backup nameservers.

### CROSS REFERENCE TO RELATED APPLICATIONS

This application is a continuation of U.S. patent application Ser. No. 14/686,557 filed Apr. 14, 2015, which claims priority to U.S. Provisional Application No. 61/986,744, filed Apr. 30, 2014, both of which are hereby incorporated by reference in their entireties.

### FIELD

The subject matter described herein relates generally to systems, devices, and methods for management of servers on the Internet and more particularly to load balancing among DNS servers.

### BACKGROUND

Network servers are critically important components of network infrastructure that provide responses to queries against directory and database services. For example, DNS nameservers translate domain names into Internet Protocol (IP) addresses in order to identify and locate computer systems and resources on the Internet. Therefore, it is common practice to provide redundant servers in the network in order to spread the network load and to protect the service against various kinds of failures.

Backup servers are configured and maintained so that they can ‘step in’ if anything happens to the regular or primary servers. In particular, Internet cloud-based servers offer a cost-effective way to provide such a backup service.

However, because of the distributed nature of the networks, backup servers may be located a long distance from some primary servers while being located only a short distance from others. Backup servers may also be hosted by third party vendors. In most cases third party vendors will charge for excess bandwidth and computing time used. Because of the traffic generated and delays incurred on the Internet, it is therefore possible to make overly heavy use of the backup servers and incur unnecessary expense. Furthermore, a single backup server may serve a number of regular servers and may not be able to accept failover traffic from multiple primary servers at the same time.

It is also important to monitor the health of servers that provide infrastructure services for example; see “A state of general functioning of the DNS that is within nominal bounds in the dimensions of coherency, integrity, speed, availability, resiliency” as described in Measuring the Health of the Domain Name System—Report of the 2nd Annual Global Symposium on DNS Security, Stability and Resiliency, February 2010, Kyoto, Japan which is herein incorporated by reference (later referred to as [KYOTO]).

DNS servers, such as the BINDS server from ISC provide statistics that may be used to monitor DNS behavior [KYOTO]. Although there is significant prior art on the various aspects of server health, there is no consensus on what comprises ‘normal’ or ‘abnormal’ DNS behavior as described in DNS Stability, Security and Resiliency—Report of the 3rd Global Symposium, October 2011, Rome, Italy which is herein incorporated by reference (later referred to as [ROME]). There is therefore a need to identify a relevant subset of factors that may be used to determine when to utilize regular servers and when to utilize backup servers.

Network clients often make use of one or more local DNS recursive servers. A DNS recursive server, which is a client of the primary nameservers, measures the response times from each primary nameserver in order to select a preferred primary nameserver to use-as described in Pro DNS and BIND, Ron Aitchison, 2005, Apress, Berkeley, Calif., which is herein incorporated by reference (later referred to as [BIND]). The DNS recursive server thereafter favors nameservers with the shortest Round Trip Time (RTT) which is the length of time it takes from when a DNS request signal is sent to the time a response to the signal is received. The DNS recursive server may not distinguish a backup server from a primary server in this environment because there is no technical differentiation between primary and backup servers. Since the DNS recursive server will not distinguish between backup servers and regular servers, the DNS recursive server may use a backup server despite the fact that it may be more expensive to do so.

In some instances backup nameservers may also be used to relieve part of a network load for one or more primary nameservers in order to maintain a high level of network performance. As described by [F5] in BIG-IP Global Traffic Manager Concepts Guide, F5 Manual, October 2011, active load balancing of web servers and other types of servers may be achieved by a number of techniques, including Round Trip Time mode. However, many of these techniques cannot address the issues of distributed, cloud-based backup servers.

Hence, it is desirable that there is a method that gracefully and automatically transitions some or all of the service to the backup server when necessary and then automatically and gracefully transitions back to the regular servers when the backup is no longer required. Thus, needs exist for dynamic nameserver prioritization.

### SUMMARY

Provided herein are embodiments of dynamic nameserver prioritization. The systems and methods described herein disclose dynamic prioritization of nameservers which can help improve network efficiency. The various methods and systems can include directing access to a plurality of servers, such as DNS nameservers, in a network including at least one regular server and at least one backup server by one or more of: a) measuring the health of the each of the servers in the network; b) measuring the network load and congestion experienced by each of the servers; c) determining according to predetermined criteria what level of responsiveness is desired of each server within a range of levels; and d) artificially controlling the perceived Round Trip Time (RTT) for messages between a client and one or more of the backup servers as measured by the client, such that the client chooses one of the regular servers or one of the backup servers based on a lowest RTT such that the lowest RTT approximates to the desired level of service responsiveness within the range of levels. Artificially controlling the perceived RTT can be accomplished by delaying messages when certain predefined network conditions are met. For example, a network switch can be enabled to delay messages using Software Defined Networking (SDN) technology. SDN is described in the white paper: Software-Defined Networking: The New Norm for Networks, Open Networking Foundation, April 2012 which is incorporated by reference herein in its entirety. The configuration of these devices and their interaction is described in detail by way of various embodiments, which are only examples.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is an example embodiment of a basic network environment.

FIG. 2a, FIG. 2b and FIG. 2c illustrate example embodiments of a delay component.

FIG. 3 is an example embodiment of a delay computation diagram including metrics.

FIG. 4 is an example embodiment of a table of round trip time (RTT) values.

FIG. 5 is an example embodiment of a delay logic flowchart.

FIG. 6 is an example embodiment of a configuration screen in a user interface.

FIG. 7 is an example embodiment of a server status screen in a user interface.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

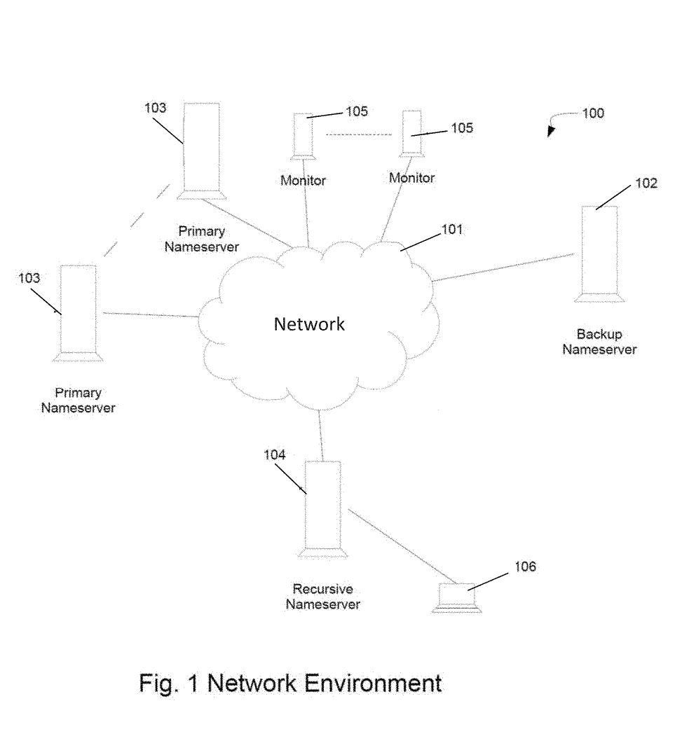

Turning now to an example embodiment, FIG. 1 is a basic network environment. In the example embodiment network environment 100 includes user device 106 and recursive nameserver 104, primary nameserver 103s, monitor 105s, backup nameserver 102 where recursive nameserver 104, primary nameserver 103s, backup nameserver 102 and monitor 105s are each connected to a Network 101, such as the Internet. Additionally, monitor 105s can be directly connected to one or more backup nameserver 102s and primary nameserver 103s or the indirectly connected, as through Network 101. Monitor 105s can be round trip time monitors.

Examples of user devices 106 include desktop computers; laptop computers; smart phones; tablets; videogame consoles; smart televisions; smart appliances; wearable smart devices such as watches, glasses and others; and other network connected devices operable to connect to a Network 101. Connections can be made over transitory media and can use numerous protocols such as Bluetooth, Wi-Fi, and others which are known in the art or later developed. Nameservers such as recursive nameserver 104, primary nameserver 103s, and backup nameserver 102 can, in various embodiments, be exclusively hardware, exclusively software or combined hardware and software servers that implement networking services in order to respond to typical and special purpose queries and can employ a directory service.

In an example embodiment of typical operation of DNS nameservers, a user device 106 connects to recursive nameserver 104 via a communicative coupling and offers a query, such as a request for the IP address of a website associated with a uniform resource locator (“URL”). Recursive nameserver 104 can reply to user device 106 with an answer if recursive nameserver 104 knows the answer, such as if recursive nameserver 104 has an IP address for the requested website stored in a database in attached or internal memory. If recursive nameserver 104 does not know the answer or is unable to locate it in a local database, recursive nameserver 104 can query other nameservers such as primary nameserver 103s and backup nameserver 102s by sending a query over Network 101 to the other nameservers. Each queried nameserver can look in its own local or attached databases for an answer to the query and respond in turn over Network 101. Responses can be affirmative or negative. Once a nameserver that knows the answer is found, the answer can be relayed back to user device 106 via Network 101 and recursive nameserver 104. Recursive nameserver 104 can update its local database with the answer and relay the answer to user device 106 such that user device 106 can use the answer in accessing the desired website.

In some instances or at certain times such as peak usage times, primary nameserver 103s can receive heavy traffic in the form of numerous requests at a time. In these instances, backup nameserver 102 can “step in” or otherwise be activated such that it can help relieve some of the traffic from primary nameserver 103s and maintain network operability at a high level. In some instances, traffic handled by backup nameserver 102 can be considered overflow traffic while in other instances it can be primary traffic. As such, backup nameserver 102 can receive some of the traffic that would normally go to primary nameserver 103s. In other instances, a primary nameserver 103 may be subject to an outage based on hardware issues, software issues, regularly scheduled updates or maintenance, unscheduled updates or maintenance, or other problems or issues. In these instances, backup nameserver 102 can step in to perform some or all of the duties normally performed by the primary nameserver 103 that is subject to the outage and therein serve as a primary nameserver for a period of time.

Controlling Round Trip Time (RTT)

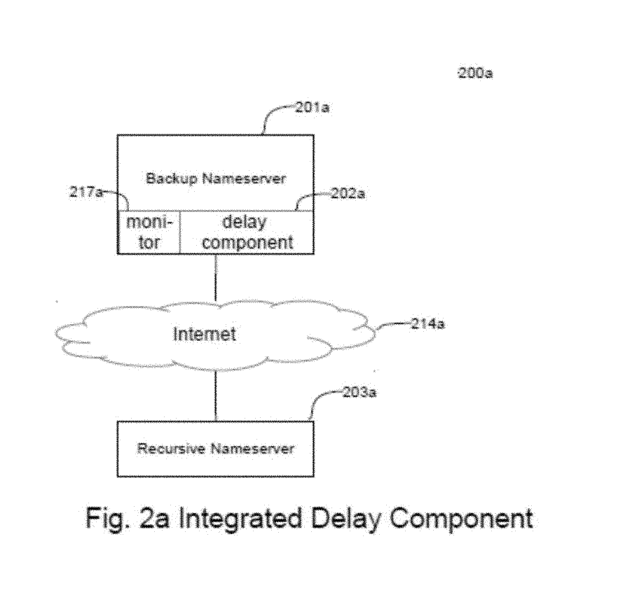

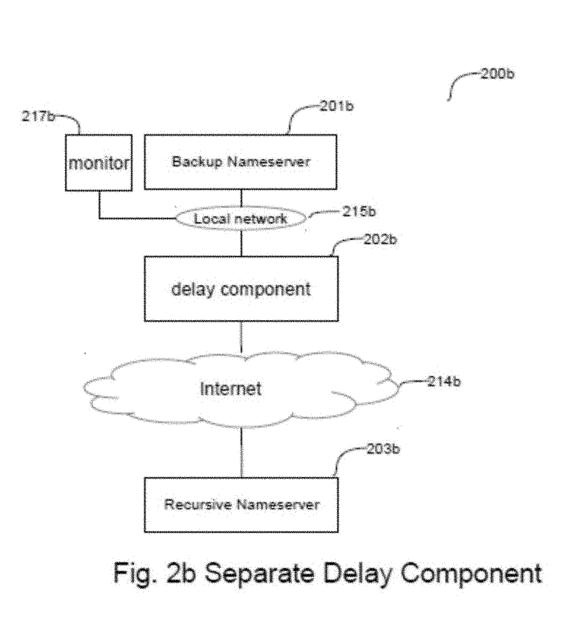

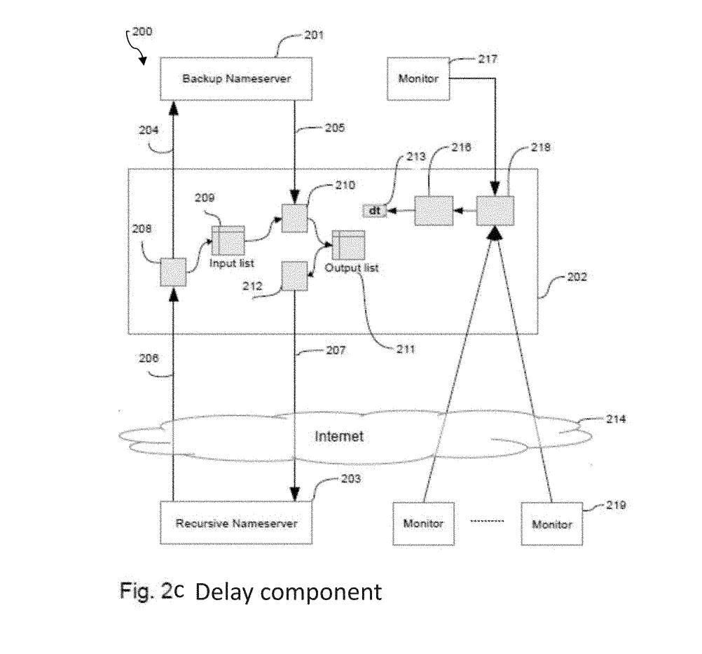

According to embodiments of the invention, controlling Round Trip Time can be important in effectively controlling usage of backup nameservers accessed using the Internet. Turning to FIG. 2c, an example embodiment of a delay component diagram 200 is shown. Backup nameserver 201s can have a network delay component 202 that adds a configurable delay to DNS network traffic 205 from backup DNS nameserver 201 to recursive DNS server 203 operating over the Internet 214. The delay component 202 may include a delay value register 213, a pre-processor 218 and a delay component 216, whereby pre-processor 218 obtains per-nameserver input information by querying both local monitor 217 and remote monitor 219s, and computes a delay value to be stored in the delay value register 213.

The delay component 202 may further include a set of networking modules including an input capture module 208, an input list 209 such as an in-memory data store, an output capture module 210, an output list 211 (such as a delay list in an in-memory data store) and an output send module 212. These components are described in more detail as follows.

In some embodiments, as illustrated in FIG. 2a, delay component 202a may co-exist on the same computer server as backup nameserver 201a as a software component of the nameserver 201a programmed to provide the integrated delay function. In some embodiments, as illustrated in FIG. 2b, delay component 202b may be a standalone device or virtual device interposed between backup nameserver 201b and the Internet 214b. For example, delay component 202b may be a Software Defined Networking (SDN) hardware switch or software virtual switch and associated software controller separate from the backup nameserver 201b and connected over a local network 215b and programmed to provide the integrated delay function.

In some embodiments, as illustrated in FIG. 2a, local monitor 217a may co-exist on the same computer server as delay component 202a. In another embodiment, as illustrated in FIG. 2b, local monitor 217b may exist as a separate device attached to local network 215b.

DNS request 206 from a DNS client such as Recursive Nameserver 203 arriving at input capture module 208 may be saved to input list 209, which can be temporary, with a time of arrival of DNS request 206. DNS request 206 may be forwarded as DNS request 204 from input module 208 to backup nameserver 201. Response message 205 from backup nameserver 201 may be received by output capture module 210 and matched with a DNS request 206 in input list 209 using the DNS message identifier in the messages. Output capture module 210 can remove request 206 from list 209 by deleting it and add Response message 205 along with a time of arrival of the DNS request 206 to output list 211. Output send module 212 can read Response message 205 from output list 211 and compute a current time delay using the time of arrival of DNS request 206, such as by using a local clock. Output send module 212 can compare this current time delay with the value stored in delay value register 213 to determine whether to remove Response message 205 from list 211 and forward as forwarded response 207 or to further delay forwarding if the value stored in delay value register 213 has not yet been reached. When the compared current time delay matches the value stored in the delay value register 213, a computed delay time has elapsed and output send module 212 can send Response message 205 to Recursive nameserver 203 as forwarded response 207. Once Response message 205 is sent as forwarded response 207, DNS Response message 205 can be removed from Output list 211.

In some embodiments, output capture module 210 can compute when to send Response message 205 as forwarded response 207 and can add Response message 205 to output list 211 according to a computed send time such that output list 211 is ordered by the computed send time. This can allow for greater processing efficiency in output send module 212 and a more accurate queuing delay because messages are removed from the output list and sent in the order they appear in the output list and therefore only the first message needs to be checked by the output send module 212.

In some embodiments, DNS request 206 messages en route to backup nameserver 201 as DNS request 204 messages may be monitored without introducing additional transmission delays on the incoming messages and copied. to the input list 209. In some embodiments time to live (TTL) values for received data can be important with respect to introduced delays. For instance, received data with short, non zero TTL values can be greatly affected by introduced delay which can cause the received data to expire if the introduced delay is too long. Alternatively, in some embodiments the delay introduced can be a small fraction of the TTL value and can therefore play a less significant role in whether the received data will expire. In some embodiments, the TTL value may be modified by output send module 212 to be increased by an amount not exceeding the delay value.

Server Health

Many embodiments include numerous components for determining nameserver health and network load and congestion such as passive monitoring, network load and congestion determination, setting performance targets and alerts, adjusting according to normal and heavy network load conditions, and server interruption conditions as described in turn below.

Passive Monitoring

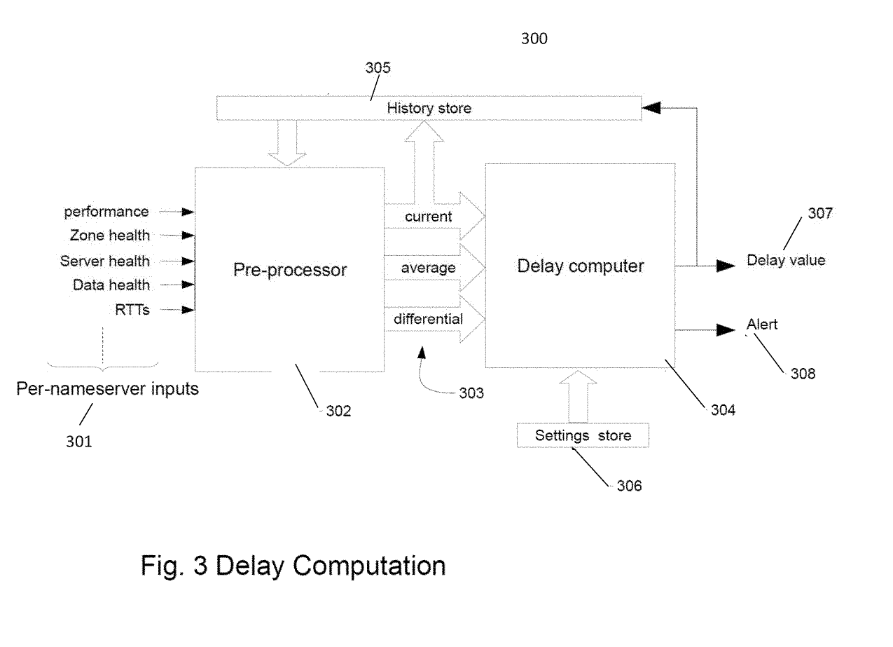

An authoritative DNS nameserver, such as a backup DNS nameserver, may support an internal monitoring component that tracks and calculates performance and other statistics and stores the tracked and calculated statistics locally on the respective servers or in attached memory. In many embodiments, the local statistics may be stored internally and may be retrieved by an external monitor 217 for use as server health input for the per-nameserver inputs 301 shown in FIG. 3. Individual DNS nameserver performance may be determined by calculating a number of successful DNS responses per second on an overall network basis and on a per-DNS zone basis where a DNS zone is a subset of the domain name hierarchy. Performance statistics can be used to determine health metrics.

There are at least 4 categories of health metrics that may be tracked: 1) Zone health, 2) Server health, 3) Operational Utilization and 4) Data Health.

1) Zone health relates to DNS-related aspects, including: zone size, zone complexity, failover configuration, the number of DNSSEC zones, DNS Update configuration, and whether secure updates are used. Zone size can include the number of DNS records in the zone, zone complexity can include the number of different DNS record types, failover configuration allows the zone to have multiple records per hostname, the number of DNSSEC zones can be the number of Domain Name System Security Extensions zones in order to provide authenticity for data and DNS Update configuration allows external clients to update zone records. The combination of these gives an overall set of zone health metrics.

2) Server Health relates to the health of hardware and software components. Health metrics can include, without limitation, database performance, database error rate, network performance, server uptime and server High Availability (HA) status. For example, the amount of computer memory consumed by the database can be tracked and compared with a predetermined, stored maximum value. The system can project the amount of computer memory consumed and compare this value with the predetermined, stored maximum value. If the amount of computer memory projected to be consumed exceeds the predetermined maximum value in the comparison step, a health alert indicator can be created and recorded internally as part of the local statistics. In another example, a well-known method can be used to determine the health of the hard drives used in a system as disclosed in U.S. Pat. No. 6,249,887 to Gray et al. “Apparatus and method for predicting failure of a disk drive”. Well-known tools are available to perform monitoring of disk health, such as “smartmontools” [http://sourceforge.net/apps/trac/smartmontools/wiki]. In many embodiments, the health alert indicator can be stored until retrieved by the external monitor 217 for use as a server health input for the per-nameserver inputs 301 shown in FIG. 3.

3) Operational Utilization can measure a percentage of server resources being used during a specific time interval. Operational Utilization can include the use of one or more metrics including; network utilization, the bandwidth used versus the available network bandwidth, memory utilization, the used memory versus the total memory available, and CPU utilization, the processor capacity loading versus the maximum capacity available.

4) Data Health can measure one or both of how current data is in a database and whether data updates are occurring. As an example, zone data can contain expiry values. When expiry values are included in zone data an overall health of the data in the zone can be measured by determining an average time to expire for data in all zones normalized by an average zone expiry interval for the zone being analyzed.

In some embodiments, there can be overlap of the four categories above, one or more categories above may be used as subsets of other categories above, or additional or fewer categories may be used.

Network monitors can regularly query accessible nameservers and receive monitored statistics information from individual nameservers. Retrieval procedures can employ a standard protocol such as Simple Network Management Protocol (SNMP) in order to transfer a DNS health-specific Management Information Base (MIB) module to each network monitor. Alternatively, an HTTP or secure HTTPS connection can be used to query and retrieve a structured data packet of statistics information. In preferred embodiments, at least one network monitor for each backup nameserver should be used to collect statistics from the backup nameserver.

Network Load and Congestion

In some embodiments, one or more network monitors can be located at strategic locations in a network such as the Internet in order to detect network congestion. An example of a network monitor 105 is shown in FIG. 1 and can be a monitoring server. Network monitors can regularly query primary nameservers and backup nameservers and measure response time in order to calculate Round Trip Time (RTT) values for the queried nameserver, using, for example, the DNS protocol. This can be done for selected nameservers, various subsets of nameservers or for all nameservers in the network. In the preferred embodiment, a monitor may be located close to each backup server, for example it may be co-located with the delay component. Other network monitors may be located at different distributed network locations that are strategically selected to measure significant RTT values across the network. They may be located in regions close to some of the recursive nameservers such as, for example, US West, US Northeast and US Southeast. RTT represents a combination of nameserver throughput delay and network latency. RTT's are used by recursive nameservers to select the most responsive nameserver (i.e shortest RTT), and therefore the preferred nameserver to use for recursive DNS queries. Responsiveness of nameservers is defined here as the representative time taken to respond to a DNS query over a measurement period. In the preferred embodiment, the representative time is taken to be a statistical average value, ignoring outliers.

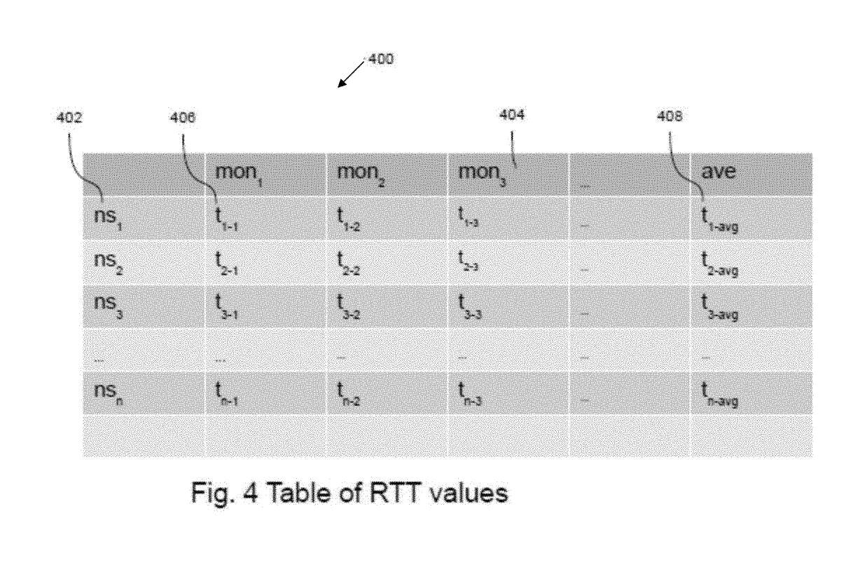

FIG. 4 shows a table 400 of primary and backup nameservers 402 (designated individually as ns1, ns2, etc) vs. Network Monitors 404 (designated individually as mon1, mon2, etc.) including RTT values 406 received from each. In the example embodiment, the average RTT values 408 for each nameserver 402 from each network monitor 404 can be computed using the received RTT values 406. In some embodiments variance can be used in addition to averages. In some embodiments RTT values 406 can be excluded from computations for monitors 404 that share a physical location with a nameserver 402 because the network delay to the nameserver is negligible. In some embodiments RTT values 406 for a monitor 404 sharing a physical location with a nameserver 402 can be used to determine the health of the nameserver 402 at the shared physical location since these RTT values 406 can measure the performance of the co-located nameserver 402 independent of any network latency.

Using the Table of RTT values 400, calculations can be performed by the delay computer to determine at least: A) whether nameservers 402 are fully operational, partially operational or non-operational, B) health metrics for nameservers 402 co-located with network monitors 404, C) network connectivity to nameservers 402 since congestion and outages can appear as abnormal RTT values 406 such as excessively high values in the table 400 and D) RTT values 406 to be used as input for Delay computations as values 301 in FIG. 3. In some embodiments delay computers are located with the delay component while in other embodiments delay computers may be located in other locations.

In some embodiments, a special DNS resource record can be created in some or all nameservers. This special DNS resource record can be used specifically for retrieval of RTT queries such that the special DNS resource record may have a time-to-live (TTL) of 0 in order to prevent the caching of the DNS response.

Setting Performance Targets and Alerts

A control parameter taught in embodiments of this invention can be a delay value imposed on responses to DNS requests which are addressed to backup nameservers. System administrators can also receive notifications and alerts generated as a result of changes in operating conditions via the network to well-known system monitoring applications.

Turning to FIG. 3, a delay computation diagram 300 is shown with computation components including pre-processor 302 and delay computer 304, per-nameserver inputs 301, settings store 306, intermediate values 303 and history store 305 used in the computation of a Delay value 307 are shown.

In an example embodiment per-nameserver inputs 301 can include input measurement values including RTT values and, if available, other health statistics information (received for each nameserver from the network monitors) which are inputted into pre-processor 302. These input measurement values may include RTT measurement values and performance measurement values, zone health measurement values, server health measurement values, data health measurement values, and others, as available.

Pre-processor 302 can create and forward intermediate values 303. This includes a) tagging the measurement values with a current time value and store them in history store 305 which is implemented in memory and send them to delay computer 304, b) computing an average of the last n measurement values, where n is a number set to represent a reasonable time of sampling multiplied by the number of measurements values per minute, for example 25 minutes×4 values/minute=100 values, and send the average to delay computer 304 and c) computing the value change differential versus the measurement values of a prior period, such as for the prior minute and send it to delay computer 304. In some embodiments, all measurement values need not be received at regular sample intervals of time, or even together, therefore linear interpolation can be used on the values present at a given time in order to approximate measurement values at desired time intervals for the purposes of computation. This allows the system a great deal of flexibility since it need not wait for exact values in order to have an accurate representation of network conditions.

Intermediate values 303 such as the current, average, and differential values can be sent from pre-processor 302 to Delay computer 304. Delay computer 304 can determine operational parameters based on intermediate values 303 and settings stored in settings store 306. History store 305 can receive current intermediate values 303 from pre-processor 302 for use in later computations by pre-processor 302.

Delay computations can be affected by numerous different levels of operation. In some embodiments, the following levels of operation can occur: a) Normal, b) Heavy load, and c) Service interruption.

a) Normal conditions can be characterized by each nameserver operating within an upper and lower prescribed health limit. These health limits define a range and are determined using the various health metrics described previously. When measured conditions exhibit stable values that are within the range as set in settings store 306 they are considered normal.

b) Heavy load conditions can be characterized by one or more nameservers exceeding a threshold query throughput setting in settings store 306, a ‘heavy load watermark’. This can be accomplished by comparing measured health metrics and RTT's with normal values, determining if the measured values exceed the threshold and if so, characterizing the conditions for the nameserver being measured as Heavy load conditions. In some embodiments one or more nameservers merely need to be trending towards exceeding the threshold, the ‘heavy load watermark’, in order for conditions to be characterized as Heavy load conditions. This can include situations with unstable values changing over a time period from a mid-range point or other designated value within the normal conditions range and approaching the heavy load watermark at a specified rate. After entering Heavy load conditions operation mode, if the load on each nameserver drops below a ‘normal load watermark’ threshold setting in settings 306 the system may revert back to its previous, Normal conditions. In some embodiments, the heavy load watermark is the same as the normal load watermark while in others the two need not be the same.

c) Service interruption conditions can arise if one or more nameservers are not operating properly. Service interruption conditions can have numerous causes including, but not limited to: hardware failure, software failure, software overloading, network congestion, maintenance, malicious attacks and others. Service interruption condition indicators can be triggered by health value issues caused by loss of communication with the nameserver; health metrics indicating an excessively out-of-range CPU, memory, network or other components when compared to normal conditions; operational error reports; excessive RTTs; and out-of range performance measurements.

In some embodiments differing levels, modes or characterizations of operation can exist, including more or fewer levels than those specified above.

In some embodiments, Delay computer 304 can compute a new Delay value 307 based on a current or future operation level, previous Delay values, measured nameserver throughputs and responsiveness derived from RTT measuments. Delay values 307 can be saved in history store 305 for use by pre-processor 302 in later calculations. Delay computer 304 can generate an alert 308 or other notification message for system administrators when operation levels change, when a significant nameserver degradation or failure is detected during the processing of performance and health information, or at other appropriate times.

Adjusting for Normal Conditions

Under normal conditions a backup server can be required to handle a very light load and a Delay value 307 can be adjusted periodically in response to input measurements to maintain the responsiveness of the primary nameservers below a target maximum response time. A delay of 500-1000 milliseconds may keep the backup lightly used, whereas a value closer to 50 mS may encourage its use. For example, for a desired maximum 1000 milliseconds DNS response time in the network, the Delay value 307 may be adjusted to this value in order for the backup server to ‘kick in’ if all of the primary servers exceed this value of response time, as measured by RTT.

Adjusting for Heavy Load Conditions

Heavy load conditions can require a backup nameserver to handle a significantly larger load than it would otherwise handle under normal operating conditions. Under heavy load conditions a Delay value 307 can be changed to a value closer to the measured RTT values for the primary nameservers than would be used under normal operating conditions. For example, 1000-2000 milliseconds may keep the backup lightly used, whereas 100 mS may encourage its use. This may cause the backup nameserver to attract more DNS traffic and relieve the load on primary nameservers. When operating under heavy load conditions, each Delay value 307 can be further adjusted to maintain query throughput (queries/sec) of each backup nameserver just below a maximum ‘high water mark’ threshold setting to prevent overuse of the backup server. Network traffic level may be a cost factor for the backup server, therefore it is important to control in many instances.

Adjusting for Server Interruption Conditions

Nameserver interruption conditions can require the backup server to take on a significant load. In some embodiments, this can be as high as a primary nameserver might normally handle. Under server interruption conditions, Delay value 307 can be adjusted lower to allow the backup nameserver to handle a different, preset throughput range of network traffic than it normally would handle. If the measured load of the backup nameserver exceeds the preset amount then Delay value 307 can be adjusted up by a predetermined step amount, for example 5 ms, in order to bring the backup nameserver throughput back within the preset range, and vice versa. In some embodiments, a special case can exist where all authoritative nameservers are out of service. In this case, all DNS traffic can be run through the backup server and the Delay value may be set to 0.

Delay Logic Flow

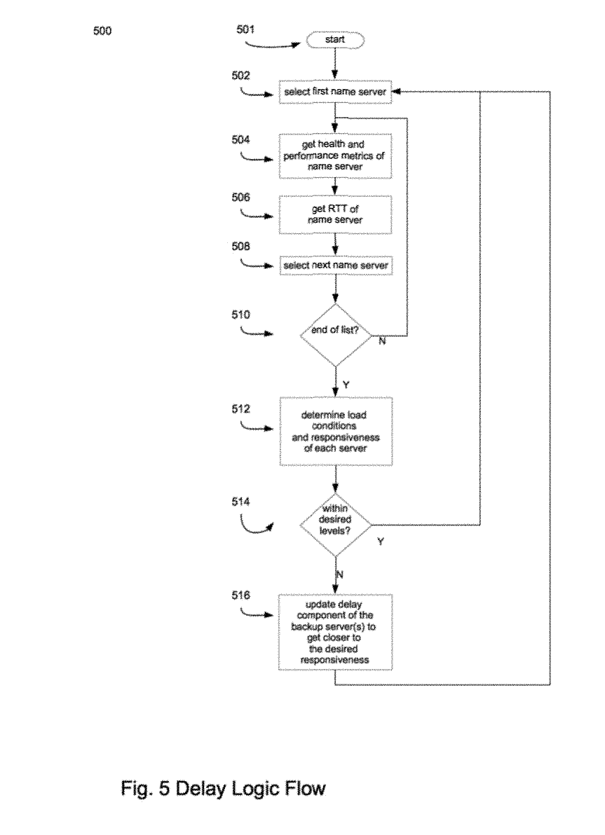

Turning to FIG. 5, an example embodiment of a delay logic flow 500 in accordance with the present invention is shown. In the example embodiment, a delay component can select a first name server in step 502 from a list of nameservers. After selecting the nameserver the delay component may; a) look up the nameserver health and performance metrics (where this is available) based on the regularly queried health parameters discussed previously, in step 504 and b) get the DNS Round Trip Time (RTT) to the nameserver in step 506. If a next nameserver in step 508 is not null in step 510 (therefore the end of the list) then the delay component can loop back to step 504.

The delay component can determine the load conditions for the nameservers and the responsiveness of each server in step 512 and in step 514 compare them to a desired level of responsiveness according to predefined values for the load conditions (Normal, Heavy or Server Interruption). If the backup nameserver is not performing within a desired level of responsiveness then the delay component can update the delay value of the backup server with new delay information, in order to cause the nameservers to operate within an optimum level of responsiveness. This feedback process can repeat at step 502 so that the desired responsiveness levels are incrementally achieved and maintained. In some embodiments where there may be multiple backup nameservers, the delay component of each backup nameserver may apply more weight to one selected primary nameserver's responsiveness than to the other primary nameservers.

Administrator Interface

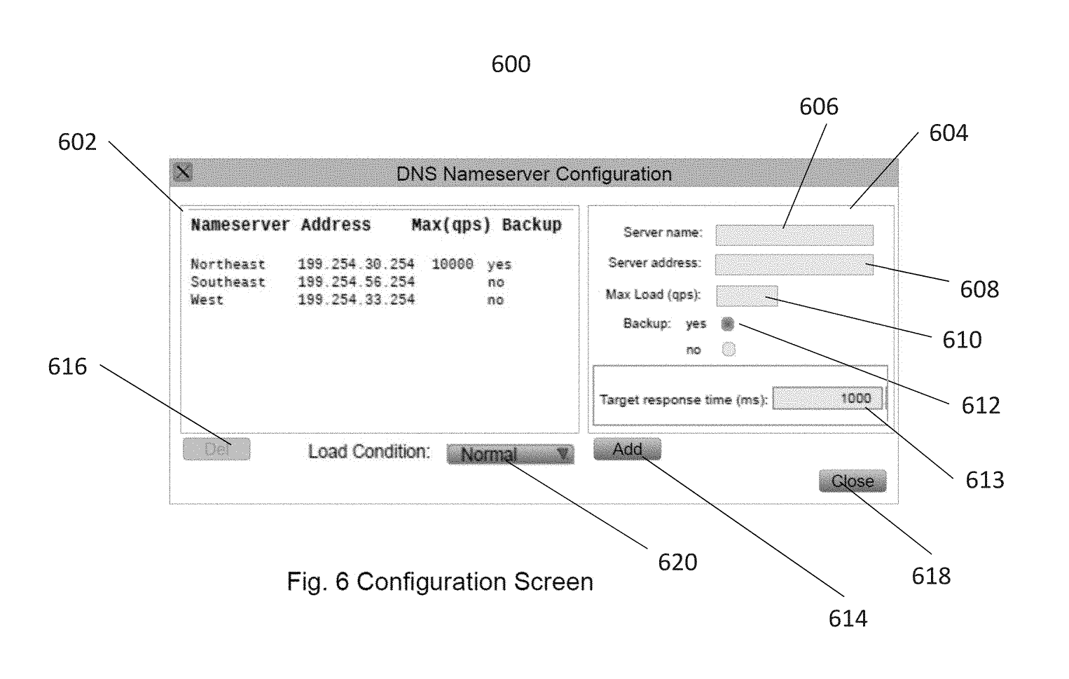

Turning to FIG. 6, an example of an administrator interface of a configuration screen 600 is shown in accordance with the present invention.

In the example embodiment, configuration screen 600 can have a nameserver listing portion 602 and nameserver addition portion 604. Control parameter Target response time 613 may be used to set the desired response time upper limit for normal operation. Nameserver listing portion 602 can include a listing of current nameservers in a nameserver network. In the example embodiment, nameserver listing portion 602 shows three nameservers in the nameserver network: Northeast, Southeast, and West. An address of each is shown as well as a maximum traffic limit (in queries per second) that each backup nameserver should be handling for the network for the selected Load Condition 620. Also included is information about whether each nameserver is designated as a backup nameserver or primary nameserver. Delete button 616 allows an administrator to delete selected nameservers from the network if required.

Nameserver addition portion 604 includes fields for an administrator to enter information regarding a new nameserver addition to a nameserver network. Included are server name field 606, server address field 608, max. load field 610 and backup designation radio buttons 612. Upon completion of the fields and designation as a backup or primary, an administrator can add the nameserver to the nameserver network by selecting the nameserver addition button 614. After a new nameserver has been added to the nameserver network it can appear in nameserver listing portion 602. Upon completion of nameserver configuration an administrator can close the screen using close button 618.

In some embodiments configuration screen 600 can include current operating conditions in order to inform an administrator about the current state of the nameserver network and the various nameservers therein. These current operating conditions can include information regarding whether each of the nameservers is currently operational.

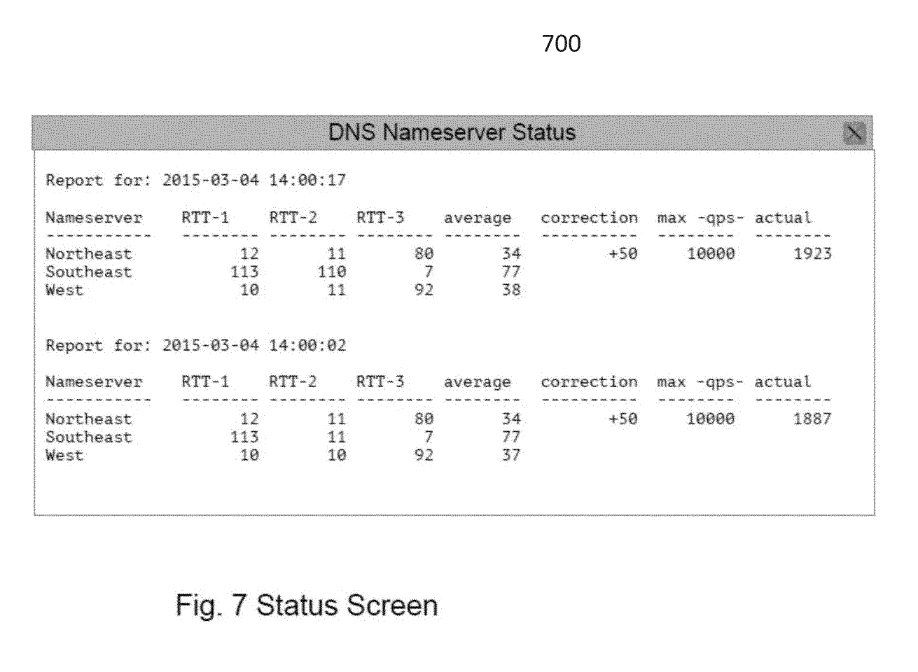

Turning to FIG. 7, a simulation of a status report screen 700 is shown. In the example status reports are shown the status of the nameserver network at a given time. For instance, two status report times are shown for the date 2014 Mar. 4. The first is from time 14:00:02 and the second is from time 14:00:17. In each report three RTT values are shown for each individual nameserver as well as an average of the RTT values for each. A correction listing is included which shows a correction delay amount. Also shown are max and actual queries per second of backup nameserver load.

Beyond DNS Servers

As described in the previous embodiment, other types of servers can be managed in a similar fashion by applying the same technique of RTT modification by introducing delays to network traffic on ports other than an example port 53 (used for DNS). For example, normal web traffic on an example port 80 and secure web traffic on an example port 443 can be influenced by inserting network delays to data using a delay mechanism. Similarly, server health and performance measurements can be used that are directed to application-specific metrics. For example; requests per second, total traffic, latency and active users in the case of a web server.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A computer-based system for prioritizing servers for a specific network protocol in a network comprising:
a plurality of communicatively coupled network servers where at least one server is a primary server and at least one server is a backup server;
at least one network monitor, wherein the network monitor monitors a round trip time (RTT) of at least one data packet sent to the primary server and at least one data packet sent to the backup server over the network;
at least one delay component operably coupled between the at least one backup server and the network, the delay component:
receiving from the at least one network monitor health status and responsiveness values for each server based on the RTT;
determining a level of operation for the server network;
computing delay information required to meet or come in below a pre-determined responsiveness target for the determined level of operation; and
introducing a network communication delay for transmission of specific network protocol message traffic from the backup servers to the network.

2. The system of claim 1, wherein, based on the delay information:
increasing the delay to message traffic from the backup server by a predefined amount if the computed delay value is greater than the current delay value; and
decreasing the delay to message traffic from the backup server by a predefined amount if the backup server is receiving less message traffic than a target maximum of message traffic for the backup server and the computed delay value is less than the current delay value.

3. The system of claim 2, wherein, based on the delay information:
increasing the delay to message traffic from the backup server if the backup server is receiving more message traffic than a target maximum of message traffic for the backup server.

4. The system of claim 1, wherein the backup server and the network monitor are co-located.

5. The system of claim 1, wherein at least one network monitor is located at a strategic distribution location on the network, in order to obtain significant RTT values.

6. The system of claim 1, wherein the delay component includes a delay computer, an input list, an output list, an input capture module, an output capture module and an output send module;
the delay computer regularly computing a delay time based on current health and RTT values and pre-determined settings.
the input capture module operable to capture and record at least one message from a client to the server in the input list;
the output capture module operable to capture a response from the server corresponding to the at least one message from the input list and to place the response in the output list, whereby the output send module removes the response from the output list and sends the response to the client after the computed delay.

7. The system of claim 1, wherein the specific network protocol is a Domain Name System (DNS) protocol.

8. A method for prioritizing servers for a specific network protocol in a network comprising:
monitoring a round trip time (RTT) of a data packet to at least one primary server and a RTT to at least one backup server for the network protocol in a network;
determining a health status and responsiveness value for each server based on the RTT;
determining the level of operation for the server network;
computing delay information required to meet or come in below a pre-determined responsiveness target for the determined level of operation; and
introducing a network communication delay for transmission of the specific network protocol message traffic from the backup server to the network.

9. The method of claim 8, wherein, based on the delay information:
increasing the delay to message traffic from the backup server by a predefined amount if the computed delay information is greater than the current delay value; and
decreasing the delay to message traffic from the backup server by a predefined amount if the backup server is receiving less message traffic than a target maximum of message traffic for the backup server and the computed delay information is less than the current delay value.

10. The method of claim 9, wherein, based on the computed delay information:
increasing the delay to message traffic from the backup server by a predefined amount if the backup server is receiving more message traffic than a target maximum of message traffic for the backup server.

11. The method of claim 8, wherein the specific network protocol is a Domain Name System (DNS) protocol.

12. A computing device in a computer network located between the computer network and a backup server, comprising components to perform a method of:
monitoring a round trip times (RTT) of a data packet to at least one primary server and a RTT to at least one backup server in the network for a specific network protocol in the network;
determining a health status and responsiveness value for each server based on the respective RTT;
determining the level of operation for the server network;
computing delay information required to meet or fall below a predetermined responsiveness target for the determined level of operation; and
enforcing a network communications delay for transmission of the specific network protocol message traffic from the backup server to the computer network.

13. The computing device of claim 12, wherein, based on the delay information the device is further enabled to:
increase the delay to message traffic from the backup server by a predetermined amount if the computed delay value is greater than the current delay value; and
decrease the delay to message traffic from the backup server by a predefined amount if the backup server is receiving less message traffic than a target maximum of message traffic for the backup server and the computed delay value is less than the current delay value.

14. The computing device of claim 13, wherein, based on the delay information the device is further enabled to:
Increase the delay to message traffic from the backup server by a predefined amount if the backup server is receiving more message traffic than a target maximum of message traffic for the backup server.

15. The device of claim 12, wherein the computing device is co-located with the backup server.

16. The device of claim 12, wherein the computing device further comprises a SDN switch and associated SDN controller and the functions of the device are effected by executing instructions stored in memory that cause a process to delay message traffic.

17. The device of claim 12, wherein the specific network protocol is the Domain Name System (DNS) protocol.

18. (canceled)
